(19) United States
(12) Patent Application Publication
(10) Pub. No.: US 2013/0125013 A1
(43) Pub. Date: May 16, 2013

(54) Distributed media player branding

(71) Applicants: Tyler J. Lettau, Hercules, CA (US); Kim P. Pimmel, San Francisco, CA (US)

(72) Inventors: Tyler J. Lettau, Hercules, CA (US); Kim P. Pimmel, San Francisco, CA (US)

(73) Assignee: Adobe Systems Incorporated, San Jose, CA (US)

(21) Appl. No.: 12/072,926

(22) Filed: Feb. 29, 2008

(51) Int. Cl. G06F 3/00

(52) U.S. Cl. 715/748

(57) ABSTRACT

Distributed media player branding is described, including receiving a request indicating retrieval of data associated with a media player, the request being sent from another media player, retrieving the data associated with the media player by the another media player, the data being configured to present at least a portion of a brand associated with the media player on a display used by the another media player, and presenting the at least the portion of the brand on the display used by the another media player.

### FIELD OF THE INVENTION

The present invention relates generally to computer programs and software architecture. More specifically, distributed media player branding is described.

### BACKGROUND OF THE INVENTION

Conventional electronic media include different types of devices for sharing, rendering, playing, or otherwise accessing digital media. For example, telephony devices are able to provide Voice over Internet Protocol (VoIP) capabilities (e.g., voice telephony, instant messaging, electronic mail (email), Internet access, and others). In some conventional solutions, access, rendering, and display (i.e., presenting) of digital media is typically performed using a graphical user interface (GUI) or user interfaces (“interfaces”). However, telephony devices are limited to functions or features that are included with limited versions of browsers installed on, for example, mobile devices, telephony devices, portable digital assistants (i.e., PDAs), smart phones, and cell phones.

Typically, conventional solutions allow users to share limited amounts of content (e.g., short messaging system (SMS) messages, emails, and text messages) without providing users with the ability to provide personalized information or content beyond that included in the content of a message. Conventional telephone applications provide customizable features on VoIP endpoint devices, but the range and limitations of customization are typically provided by the equipment manufacturers or service providers, enabling users to identify short cuts, soft keys, and other usability preferences. However, adoption of new technologies such as VoIP are often enhanced by providing users with the ability to personalize information beyond that of their messages or specific, short-lived calls or exchanges. Further, conventional interfaces are often limited to features or functions (e.g., on-screen elements, items, or widgets that provide both a media-based function configured for user interaction) provided by interface designers, website providers, or internet service providers. Still further, conventional media players and interfaces have been developed to provide users with the ability to personalize music, friend, email recipient/sender, address, and other types of lists. However, conventional media players are typically limited to branding or other personalization aspects provided by player providers and do not permit users to modify layout, appearance, or any other aspect associated with branding.

Thus, what is needed is a solution for personalization of media-based interfaces, without the limitations of conventional techniques.

### BRIEF DESCRIPTION OF THE DRAWINGS

Various embodiments of the invention are disclosed in the following detailed description and the accompanying drawings:

FIG. 1A illustrates an exemplary distributed media player branding system;

FIG. 1B illustrates an alternative exemplary distributed media player branding system;

FIG. 2 illustrates an exemplary distributed media player branding application architecture;

FIG. 3A illustrates an exemplary distributed media player branding interface;

FIG. 3B illustrates an alternative exemplary distributed media player branding interface;

FIG. 3C illustrates another alternative exemplary distributed media player branding interface;

FIG. 3D illustrates still another alternative exemplary distributed media player branding interface;

FIG. 3E illustrates yet another alternative exemplary distributed media player branding interface;

FIG. 4A illustrates an exemplary distributed media player branding process;

FIG. 4B illustrates an alternative exemplary distributed media player branding process;

FIG. 4C illustrates another exemplary distributed media player branding process;

FIG. 4D illustrates yet another exemplary distributed media player branding process;

FIG. 5A illustrates exemplary types of graphical representation;

FIG. 5B illustrates exemplary types of element branding;

FIG. 5C illustrates exemplary types of data formats;

FIG. 6 illustrates an exemplary computer system suitable for distributed media player branding.

### DETAILED DESCRIPTION

Various embodiments of the invention may be implemented in numerous ways, including as a system, a process, an apparatus, or a series of program instructions on a computer readable medium such as a computer readable storage medium or a computer network where the program instructions are sent over optical or electronic communication links. In general, operations of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some examples, the described techniques may be implemented as an application or as a module or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including C, Objective C, C++, C#, AIR™, Flex™, Java™, JavaScript™, ActionScript™, Ajax, COBOL, Fortran, ADA, XML, HTML, DHTML, XHTML, HTTP, XMPP, and others. Design, publishing, and other types of applications such as Illustrator®, Photoshop®, Dreamweaver®, Shockwave®, Fireworks®, InDesign®, and others may also be used to implement the described techniques. The described techniques may be varied and are not limited to the examples or descriptions provided.

Techniques for distributed media player branding are described, including receiving a request indicating retrieval of data associated with a media player, retrieving the data associated with the media player, and presenting at least a portion of a brand on a display used by another media player. In some examples, indication and retrieval of data may be performed using a data communication link (hereafter “data link”) between one or more media players (e.g., Adobe® Flash® Player developed by Adobe Systems, Incorporated of San Jose, Calif., and others). In some examples, a media player may be any type of hardware, software, or a combination thereof configured to play content in one or more types of formats. Media players may be implemented as endpoints at either end of a data communication link and, when a session or other type of direct or indirect data link is established between endpoints, content may be shared, presented, managed, created, authored, edited, deleted, modified, or otherwise accessed. In other examples, a request may be a message requesting data communication between two or more endpoints. In still other examples, an endpoint may refer to various types of end devices, applications, software, hardware, desktop or notebook computers, servers, clients, personal digital assistants (“PDAs”), smart phones, or others, regardless of whether implemented in a wireless, wired, optical, or other type of public or private data communication or networking environment. In yet other examples, a media player may be a computer plug-in, widget, applet, or otherwise application (“application”) used to play back a single media or multiple format media (“multimedia”) file, which may include logical groups of data or information that may be used to instantiate an object, process, or set of objects or processes when invoked. As used herein, the term “object” may generally refer, to a function, a format, or a graphical representation associated with data presented on a media player. Multimedia files may include content, data, or information such as audio and video that may be used to “brand” or otherwise personalize a media player and provide users with the ability to share individual brands or personalization files that enable recipients to receive and present another user's personalization (i.e., brand) on a media player. In other examples, various types of data or information besides multimedia files may be used to perform the described techniques. In some examples, a brand may include a label, name, avatar, icon, symbol, or other element that may be configured to identify an owner or user. In other examples, a brand may include any type of data that, when processed, is used to implement user identification, personalized interests, ownership or intellectual property rights (e.g., a copyright over digital art work created by a given user), or other features that may be used to instantiate a name, a term, a design, a symbol, and the like. For example, a brand may label rich media content (e.g., advertisements showing consumer products, television shows, cinematic shows, or others) using elements, including but not limited to, background images, banners, logos, overlay advertisements, or others. In other examples, a display may be a static visual representation of an output (e.g., a brand) on a media player. In still other examples, a media player, in data communication with another media player, may provide a brand, and the brand may be presented on the other media player. In some examples, the described techniques may be implemented differently and are not limited to the descriptions provided.

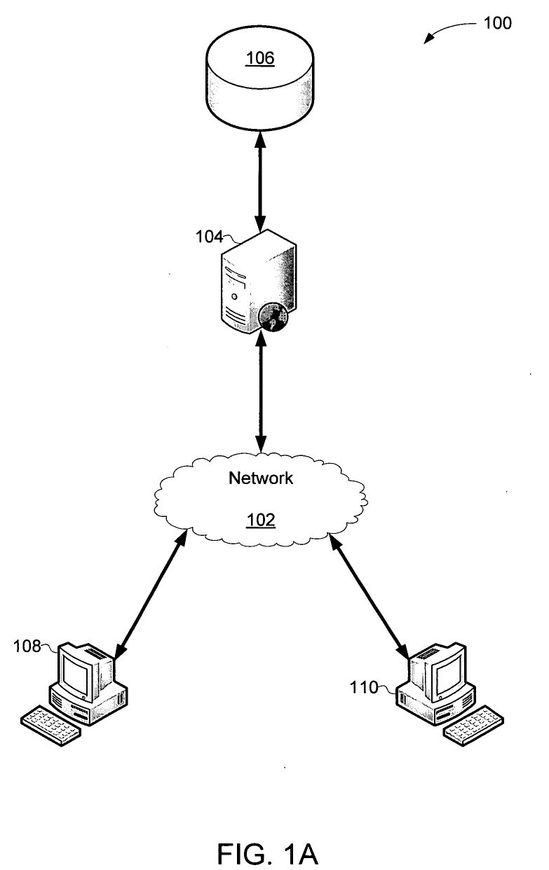

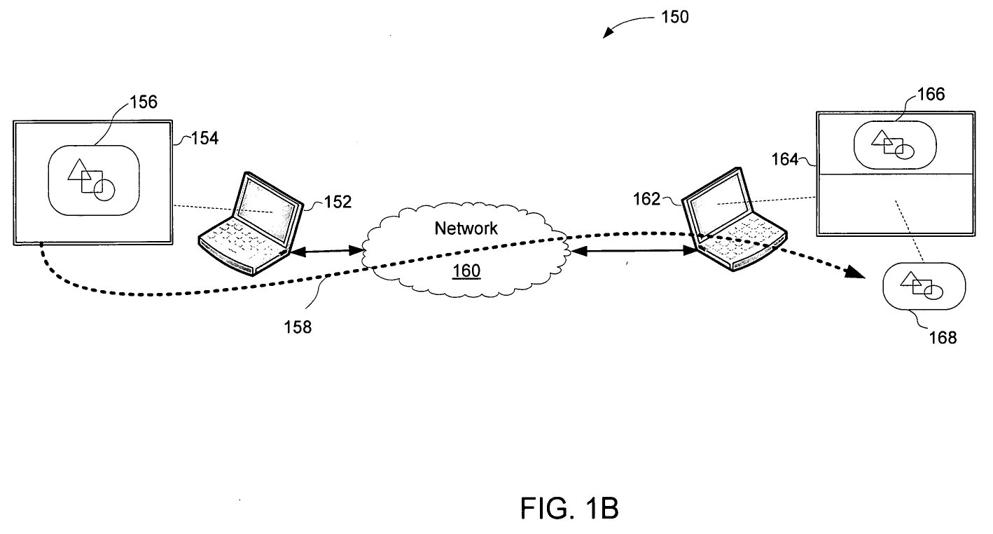

FIG. 1A illustrates an exemplary distributed media player branding system. Here, system 100 includes network 102, server 104, repository 106, and clients 108-110. The number and type of clients 108-110 may be varied and are not limited to those shown. In some examples, system 100 and the included elements may be varied in number, function, design, and other characteristics, and are not limited to the examples provided. In some examples, network 102 may be the Internet, a local area network (“LAN”), wide area network (“WAN”), wireless local area network (“WLAN”), municipal area network (“MAN”), or other type of network. Data may be exchanged between clients 108-110 and server 130, which may be direct or indirect data communication with repository (e.g., database, storage area network (“SAN”), network attached storage (“NAS”), and others) 106. In some examples, data may be transmitted by client 108 using a media player (not shown) to present a brand (e.g., a skin, a badge, a banner, an advertisement, or others) associated with the media player to client 110. In other examples, client 110 may use another media player (not shown) to present a brand (or portion thereof) generated by client 108. In still other examples, data may be requested by client 110. Data may be used to provide requested content to client 110 and, once presented, may include a voice communication between client 108 and client 110. In other examples, data may be delivered by server 104 from repository 106 using a type of data format, such as a web feed. In still other examples, a web feed (e.g., Really Simple Syndication (“RSS”), Atom, or others) may be a data format used to provide a media player with frequently updated content using a brand. In some examples, system 100 may be configured and implemented differently than shown and described.

FIG. 1B illustrates an alternative exemplary distributed media player branding system. Here, system 150 includes client 152, media player 154, brand 156, data link 158, network 160, client 162, media player 164, brand 166, and brand 168. In some examples, system 150 may implement data communication between client 152 and client 162. For example, client 152 may send data to client 162 using media player 154. In other examples, media player 154 may establish data link 158 to communicate with media player 164 at client 162. In still other examples, data link 158 may be used to implement voice communication (e.g., VoIP) using network 160 and protocols (e.g., Internet Protocol version 6 (“IPv6”), Multiprotocol Label Switching (“MPLS”), or others) handling speech compression techniques. In some examples, media player 164 may receive a request to retrieve data sent by media player 154. In other examples, data sent over network 160 may be associated with media player 154. For example, client 152 may implement branding techniques (i.e., using distinguishing graphical representations indicating ownership) to identify media player 154 to media player 164. In some examples, media player 154 may present brand 156 with (or without) data link 158 to media player 164. In other examples, brand 156 may include a graphical representation such as an avatar. For example, an avatar may be a computer-generated representation of a user, and the avatar may be associated with a handle (e.g., a screen name, a username, or others) of the user. In still other examples, brand 156 may include a skin, in which the skin may present data associated with media player 154. For example, a skin may be a texture that may change an appearance of a virtual machine (e.g., media player 154, media player 164). In some examples, media player 154 may send brand 156 to media player 164 using data link 158. In other words, media player 164 may receive a request to initiate data communication with media player 154, and receive data that may contain brand 156. In other examples, branding of media player 154 may be presented on media player 164 (or portion thereof) using brand 168. In still other examples, media player 164 may present brand 166 simultaneously (or substantially simultaneously) with brand 156 when in data communication with media player 154. For example, data communication between client 152 and client 162 may include textual communications (e.g., chat rooms, instant messaging), voice communications (e.g., Voice-over-Internet-Protocol (“VoIP”)), or video communications (e.g., video conferencing) that may provide identification of media player 154 on a display used by media player 164. In some examples, system 150 may be configured and implemented differently than shown and described.

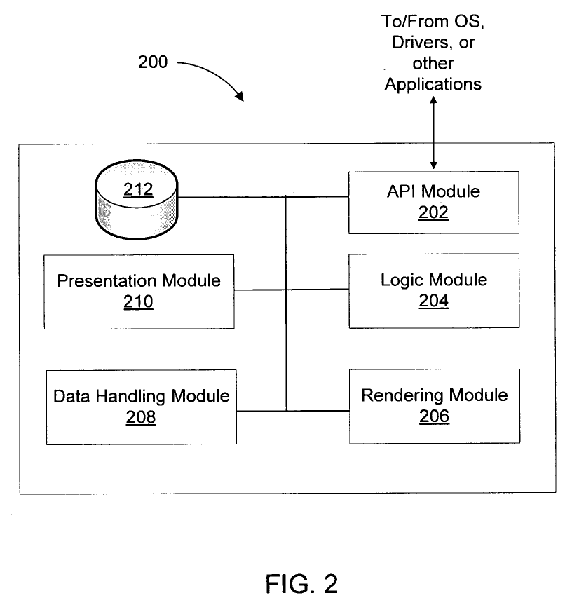

FIG. 2 illustrates an exemplary distributed media player branding application architecture. Here, application 200 includes application programming interface (“API”) module 202, logic module 204, rendering module 206, data handling module 208, presentation module 210, and repository 212. In some examples, application 200 may be used to implement brand 156 (FIG. 1B). Logic module 204 may be used to provide control signals and data to one or more of application programming interface module 202, rendering module 206, data handling module 208, presentation module 210, and repository 212. Here, data transferred over API module 202 may be used by application 200 to support requests for services, for example, media player 154 (FIG. 1B). API module 202 may be used to transfer data between application 200 and modules 204-212 and other sources or destinations (e.g., an operating system, another application, port, or other source/destination). In some examples, requests may be determined after establishing a data link from media player 154 (FIG. 1B) to media player 164 (FIG. 1B). For example, media player 154 (FIG. 1B) may request to send data associated with brand 156 (FIG. 1B), and request to present brand 156 (FIG. 1B) on a display using media player 164 (FIG. 1B). In some examples, requests may be used to retrieve other data (e.g., advertisements, promotions, sponsorships, or others), which may be determined, based on requests to access repository 212. In other examples, repository 212 may be implemented using a database configured for local or remote access, data bank, data mart, data warehouse, storage area network (“SAN”), network attached storage (“NAS”), redundant array of independent drives or disks (“RAID”), or any other type of storage facility configured to store data that may be accessed by application 200. In other examples, repository 212 may be a repository or other type of storage facility configured for remote access. For example, repository 212 may be in data communication with other sources (e.g., electronic devices, web page, and the like) using API module 202 across network 160 (FIG. 1 B) to request access to rich media content (e.g., advertisements, news feeds, or others).

In some examples, application 200 may implement rendering module 206 to convert data from API module 202 into visual form to present on a media player (e.g., media player 154 (FIG. 1B), media player 164 (FIG. 1B)). For example, data received by media player 164 (FIG. 1B) may be written in a language (e.g., extensible markup language (“XML”), extensible stylesheet language transformation (“XSLT”), cascading style sheets (“CSS”), JavaScript, or others) used to implement a graphical representation, and change a visual appearance of media player 164 (FIG. 1B). In other examples, rendering module 206 may implement an object with use of data retrieved by API module 202 to facilitate branding of a media player. For example, rendering module 206 may render, depict, display, or otherwise present (“present”) a graphical representation (e.g., a skin, a brand, or others) using content and objects managed by data handling module 208. In some examples, application 200 may implement data handling module 208 to handle data retrieved or generated by application 200. For example, data being handled by data handling module 208 may include rich media content that may be combined with objects. In other words, data handling module 208 may implement a brand (e.g., brand 166 (FIG. 1B) using an advertisement in combination with an avatar on a common display. In other examples, data handling module 208 may use data including web feeds (e.g., RSS) to populate media player 164 (FIG. I B) with information associated with rich media content. In some examples, application 200 may implement presentation module 210 to arrange, organize, position, or otherwise configure (“configure”) objects and rich media content to present a brand (e.g., brand 154 (FIG. 1B)) using a display on a media player. In other examples, presentation module 210 may configure other objects and rich media content retrieved by API module 202 from another media player (e.g., media player 154 (FIG. 1B)) in data communication with a media player (e.g., media player 164 (FIG. 1B)). For example, there may be a data link (e.g., data link 158 (FIG. 1B)) between two or more media players, and the data link may support requests to present a brand originating from a media player (e.g., media player 154 (FIG. 1B)) configured for display using another media player (e.g., media player 164 (FIG. 1B)). In still other examples, application 200 may be implemented differently and may also vary in architecture, function, design, operation, or other attributes.

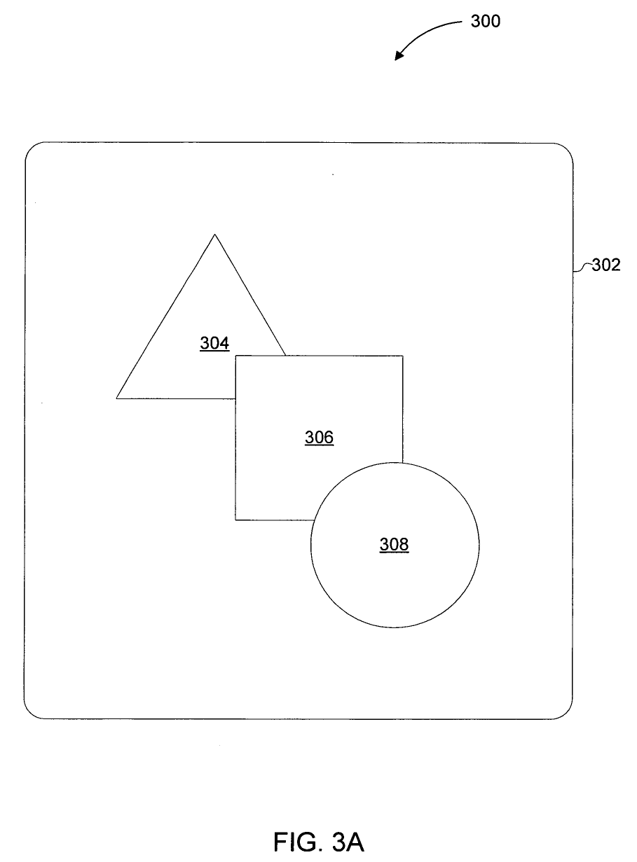

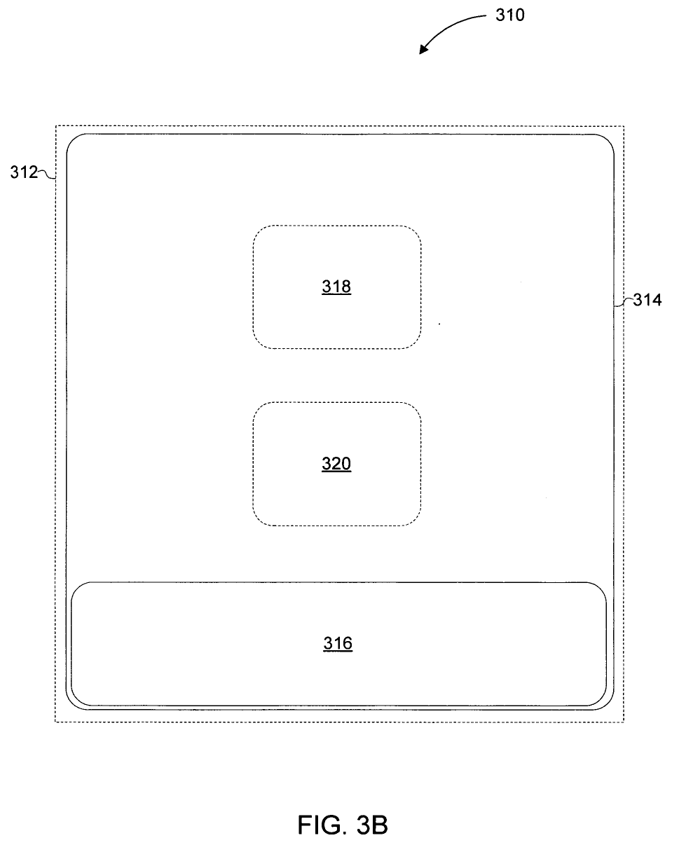

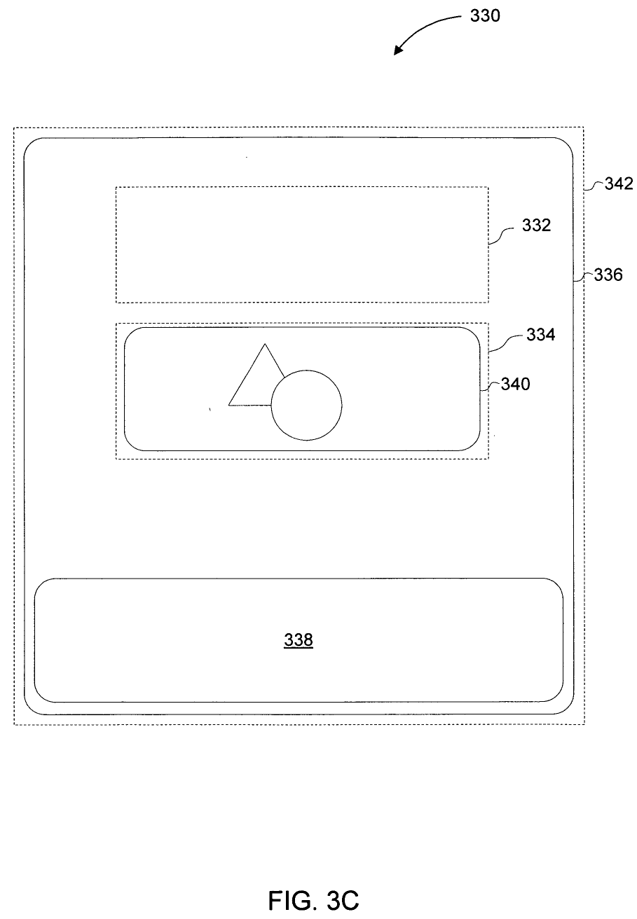

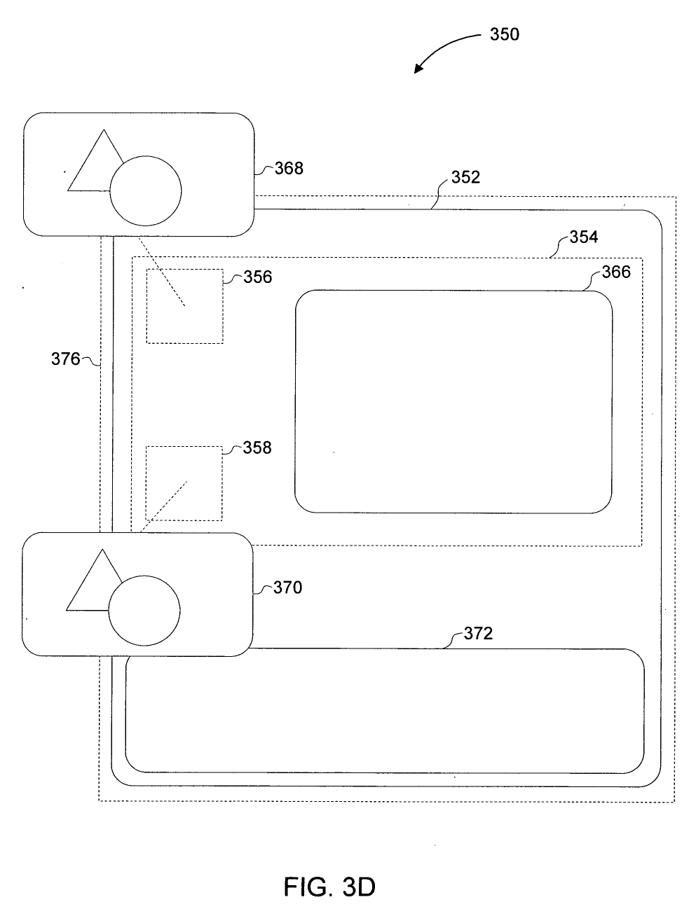

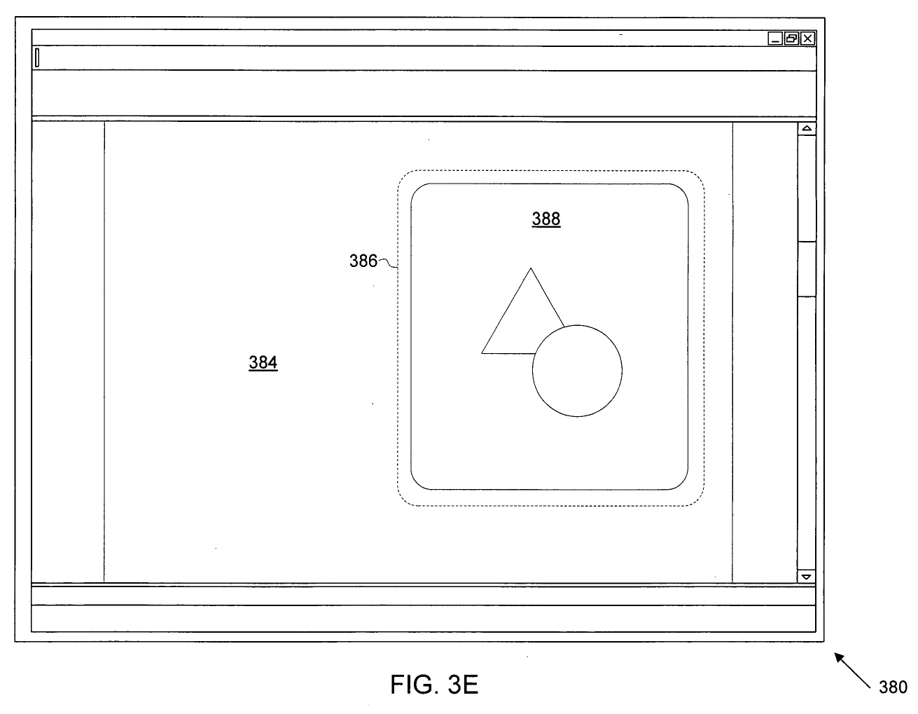

FIG. 3A illustrates an exemplary distributed media player branding interface. Here, interface 300 includes brand 302, field 304, format 306, and graphical representation 308. In some examples, interface 300 may implement brand 302 to use an object or set of objects configured for presentation on, for example, a media player. For example, brand 302 may use field 304 to receive an input from a user (e.g., a mouse click, a mouse-over, “click-and-drag” selection, or others). In other examples, field 304 may be an area providing a function to control a media player. For example, a media player may be configured for use in a voice communication, in which the media player may include functions (e.g., answer, send, numerical keypad, or others) to control the voice communication. In still other examples, a media player may be configured for use in a textual communication, and implement field 304 to provide other functions (e.g., text window, chat send, chat receive, or others) associated with the textual communication. In some examples, interface 300 may implement format 306 to provide an arrangement of data presented on a media player. For example, format 306 may arrange data to provide information using a video or a web page associated with a media player. In other words, a media player may be inserted, installed, or otherwise integrated (“integrated”) with a web page (e.g., a social network portal, blog, or others) implementing branding techniques as described. In some examples, interface 300 may implement graphical representation 308 to change a visual appearance of field 304. For example, graphical representation 308 may provide texture mapping on field 304, and maintain functionality associated with a media player. In some examples, texture mapping may be a process to apply detail, texture, or color to a surface associated with a media player. In other examples, graphical representation 308 may use one or more elements (e.g., visual, audio, animation, or others) used for presenting brand 302 on a media player. Further, interface 300 and the above-described elements may vary in architecture, function, design, operation, implementation, or other attributes.

FIG. 3B illustrates an alternative exemplary distributed media player branding interface. Here, interface 310 includes media player 312, brand 314, banner 316, and fields 318-320. In some examples, interface 310 may implement brand 314 on media player 312 to present a branding technique on one or more endpoints. For example, a branding technique may include one or more processes configured to change a visual appearance of a media player being presented on an endpoint (e.g., client 108 (FIG. 1A)). Further, a branding technique may include changing a visual appearance of another media player using brand 314 (or portion thereof) retrieved from a data link with a media player. In other examples, brand 314 may implement banner 316 to distribute rich media content around an element or set of elements being presented on media player 312. For example, banner 316 may be implemented using a graphical representation including an overlay advertisement. In some examples, an overlay advertisement may present content statically (i.e., non-interactive to an input) on brand 314. In other examples, an overlay advertisement may present content dynamically (i.e., frequently updated) in connection with network 160 (FIG. 1B). In still other examples, an overlay advertisement using banner 316 may provide content having commercial incentives. In some examples, fields 318-320 (e.g., an area having a function to control usage of voice, chat, text, video, or other types of communication interfaces) may be configured for operation with brand 314. For example, brand 314 may be implemented on media player 312 without having to modify functionality associated with media player 312. In other examples, interface 310 and the above-described elements may be varied in number, function, design, and other characteristics, and are not limited to the examples provided.

FIG. 3C illustrates another alternative exemplary distributed media player branding interface. Here, interface 330 includes fields 332-334, brand 336, banner 338, brand 340, and media player 342. In some examples, interface 330 may implement brand 336 on media player 342 and on another media player (not shown) in data communication with media player 342. For example, media player 342 may establish a voice communication (e.g., VoIP) using a data link with another media player. Further, media player 342 may distribute brand 336 over the data link. In other examples, brand 336 may be implemented to change a visual appearance of media player 342, including fields 332-334 (e.g., controls to transmit, receive, or others). In some examples, banner 338 may be implemented on brand 336 to provide rich media content related in subject matter with brand 336. In other examples, banner 338 may provide other content that presents commercial subject matter. In some examples, brand 340 may be presented on field 334 to change a visual appearance of an element (e.g., a button, a hyperlink, or others) associated with media player 342. In other examples, interface 330 and the above-described elements may be varied in number, function, design, and other characteristics, and are not limited to the examples provided.

FIG. 3D illustrates still another alternative exemplary distributed media player branding interface. Here, interface 350 includes brand 352, fields 354-358, brands 366-370, banner 372, and media player 376. In some examples, interface 350 may provide a textual communication (e.g., a chat room, an instant message, or others) with one or more fields (e.g., fields 354-358) using brand 352 on media player 376. In other examples, interface 350 may implement a chat display (e.g., field 354) to present content associated with a textual communication, such as user identification, communication data, or others. In still other examples, brand 366 may present an element associated with media player 376, such as a background image or other element of the like. In some examples, fields 356-358 may be implemented to provide user identification of each user engaged in a textual communication using media player 376. For example, brands 368-370 may present a graphical representation associated with user identification provided by fields 356-358, respectively. In other words, brands 368-370 may present an avatar of each user engaged in a textual communication. In some examples, media player 376 may establish a data link to another media player (not shown), and present brand 352 including one or more elements as described. In other examples, banner 372 may provide rich media content associated with media player 376. In still other examples, banner 372 may present other content with commercial incentive (e.g., a product advertisement, a corporate sponsorship, or others). In other examples, interface 350 and the above-described elements may be varied in number, function, design, and other characteristics, and are not limited to the examples provided.

FIG. 3E illustrates yet another alternative exemplary distributed media player branding interface. Here, interface 380 includes web page 384, media player 386, and brand 388. In some examples, interface 380 may be implemented on web page 384 using media player 386. For example, web page 384 may provide a data link from media player 386 to another media player (not shown) to provide a voice communication. In other examples, brand 388 may be presented on media player 386, and may be sent across network 160 (FIG. 1B) to use a display of another media player in data communication with media player 386. In still other examples, web page 384 may access a location (e.g., a repository associated with web page 384) storing information that may be presented on brand 388. Further, brand 388 may present information dynamically when media player 386 retrieves data after web page 384 accesses a location. In some examples, interface 380 and the above-described elements may be varied in function, design, and other characteristics, and are not limited to the examples provided.

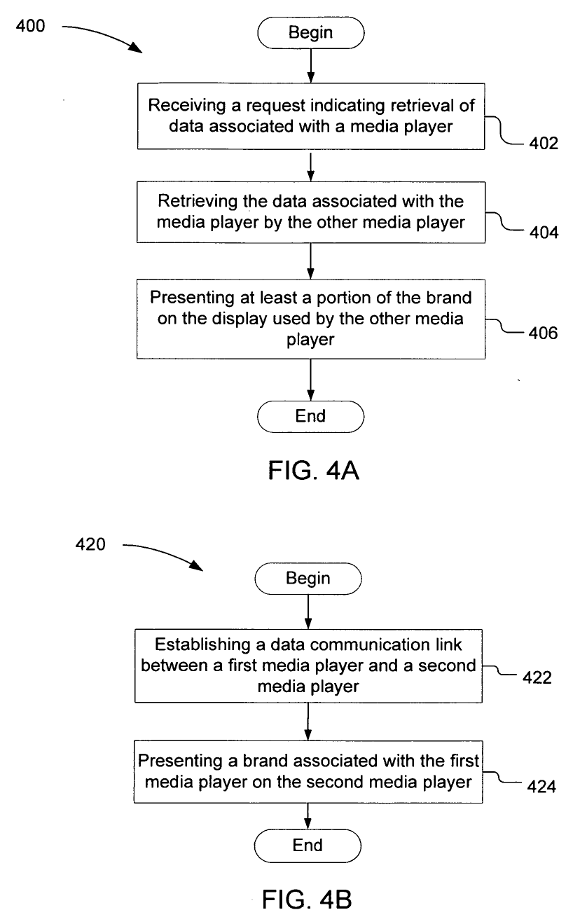

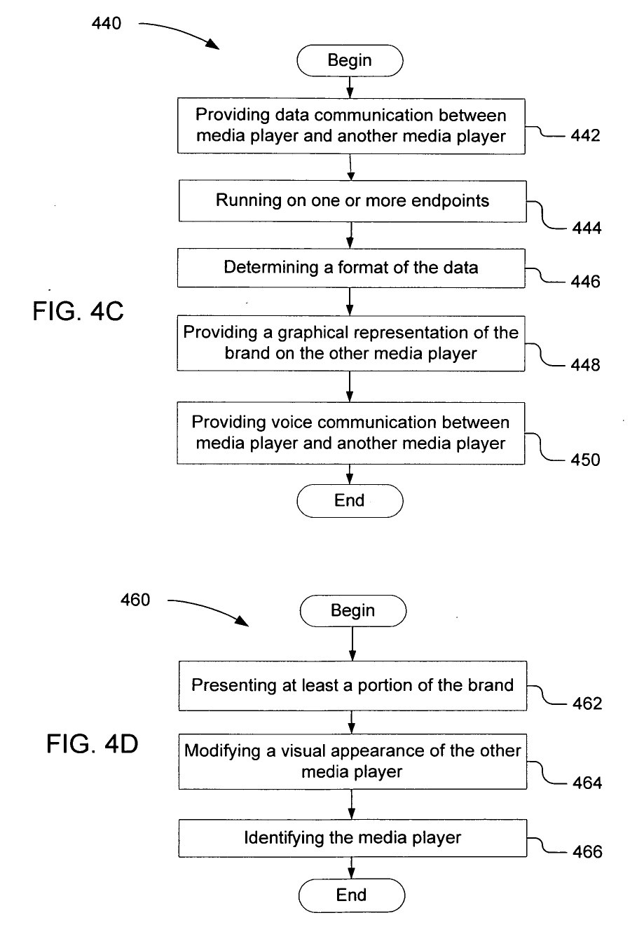

FIG. 4A illustrates an exemplary distributed media player branding process. Here, process 400 begins by having client 108 (FIG. 1A) receive a request indicating retrieval of data associated with a media player (402). In some examples, a media player may be in data communication with another media player. For example, a media player may establish a voice communication with another media player. In other examples, a voice communication may provide data providing a brand to be displayed by a media player. In still other examples, a media player may retrieve data associated with another media player (404). In other words, a media player may receive a brand transmitted by another media player. In some examples, a media player may present at least a portion of a brand using a display of the media player (406). Further, a brand displayed on a media player after receiving the brand from another media player may provide identification of the other media player. In other examples, the above-described process may be varied in implementation, order, execution, or operation, and is not limited to the examples provided above.

FIG. 4B illustrates an alternative exemplary distributed media player branding process. Here, process 420 begins by having server 104 (FIG. 1A) or other node of network 160 (FIG. 1A) establish a data communication link (“data link”) between a media player and another media player (422). For example, a media player may facilitate in establishing a data link to provide communications (e.g., voice, video, chat, text, or others) with another media player. In other examples, a brand may be presented on a media player, which may provide information associated with the media player. In still other examples, a data link may transport a brand from a media player, and be presented on another media player in data communication with the media player (424). Further, a brand may be presented on one or more endpoints in data communication with a media player. In some examples, the above-described process may be varied in implementation, order, or operation, and is not limited to the examples shown and described.

FIG. 4C illustrates another exemplary distributed media player branding process. Here, process 440 begins by server 104 (FIG. 1A) providing data communication between a media player and another media player (442). In some examples, a media player in data communication with another media player may be running on one or more endpoints (444). In other examples, a request to establish a data communication link may facilitate in determining a format of the data (446). In still other examples, in determining the format of the data, a media player may provide a graphical representation of a brand on another media player in data communication with the media player (448). In other words, a brand sent by a media player may be used on a display of another media player. In some examples, data communication between a media player and another media player may include providing voice communication (450). In some examples, the above-described process may be varied in implementation, order, or operation, and is not limited to the examples shown and described.

FIG. 4D illustrates yet another exemplary distributed media player branding process. Here, process 460 begins by having a media player present at least a portion of a brand (462). For example, a media player in data communication with another media player may present a brand received from the other media player. In other examples, presenting at least a portion of a brand may include modifying a visual appearance of a media player (464). Further, a media player presenting a brand may not have its fields (i.e., controls of the media player) changed, but have its visual appearance changed by the brand. In still other examples, presenting a brand from a media player using another media player may provide identification of the media player (466). In other words, a media player using a brand sent by another media player may provide data in identifying the other media player, including identifying a user associated with the brand. In some examples, the above-described process may be varied in implementation, order, or operation, and is not limited to the examples shown and described.

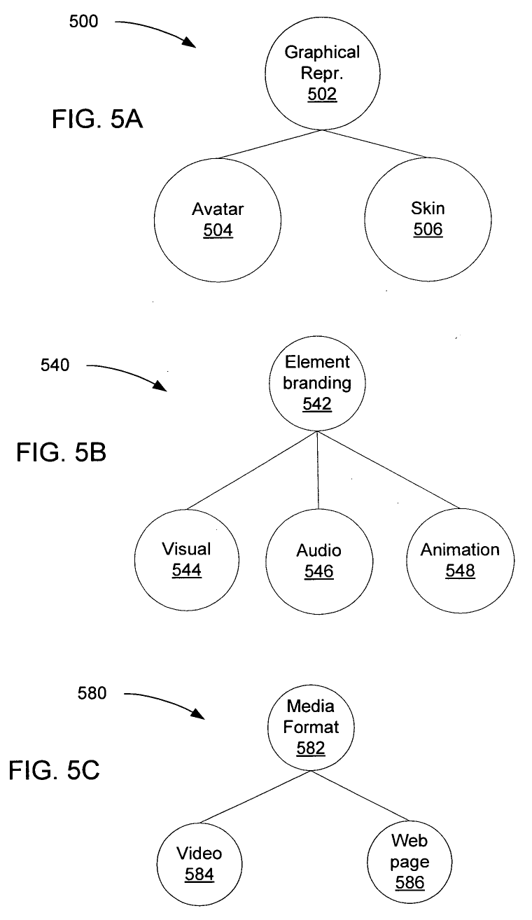

FIG. 5A illustrates exemplary types of graphical representation. Here, graphical representation 502 may include, but is not limited to, avatar 504 and skin 506. Other types of representations may be used with distributed media player branding applications and techniques such as those described above. In some examples, graphical representation 502 may be an element or set of elements that form an image to be applied on a surface of a media player. For example, avatar 504 may be a computer-generated image representation of a user. In other examples, avatar 504 may be transmitted over a data link, and be presented on another media player. In some examples, skin 506 may be a computer-generated texture that may be applied on a surface of a media player. In other examples, skin 506 may change a visual appearance of a media player, and not change functionality of fields associated with a media player. In other examples, graphical representation 502 and the above-described examples may be varied and not limited to the examples provided above.

FIG. 5B illustrates exemplary types of element branding. Here, element branding 542 may include, but is not limited to, visual 544, audio 546, and animation 548. Other types of elements may be used with distributed media player branding applications and techniques such as those described above. In some examples, a brand may include data or information that may be presented using an element, such as visual 544. For example, visual 544 may be an image (e.g., a photograph, a cartoon, a drawing, a text, or others) that describes at least a portion of a brand being presented on a media player. In still other examples, a brand may provide information in a different form other than a visual representation, such as audio 546. For example, audio 546 may provide an audio stream (e.g., a voice, a musical note, a sound, or others) integrated with a brand using one or more elements changing a visual appearance of a media player. In yet another example, a brand may integrate a display of movie-like sequence of images, for example, animation 548. In some examples, animation 548 may provide rich media content that may be presented on one or more endpoints, including a web page. In other examples, element branding 542 and the above-described examples may be varied and not limited to the examples provided above.

FIG. 5C illustrates exemplary types of data format. Here, data format 582 may include, but is not limited to, video 584 and web page 586. Other types of formats may be used with distributed media player branding applications and techniques such as those described above. In some examples, data associated with a media player may be organized, positioned, styled, or otherwise arranged (“arranged”) according to a display of a media player. For example, a brand may be presented on a media player supporting video content, and may be arranged to follow a format, such as video 584 that may handle the video content. In other examples, a media player may be an application (e.g., a widget, a plug-in, an applet, or others) on a web page providing communication with another endpoint, and the media player including a brand may be arranged to follow a format handling the web page. Further, a brand hosted on a web page may change a visual appearance of a media player in data communication with another media player presented on another endpoint accessing the web page. In some examples, data format 542 and the above-described examples may be varied and not limited to the examples provided above.

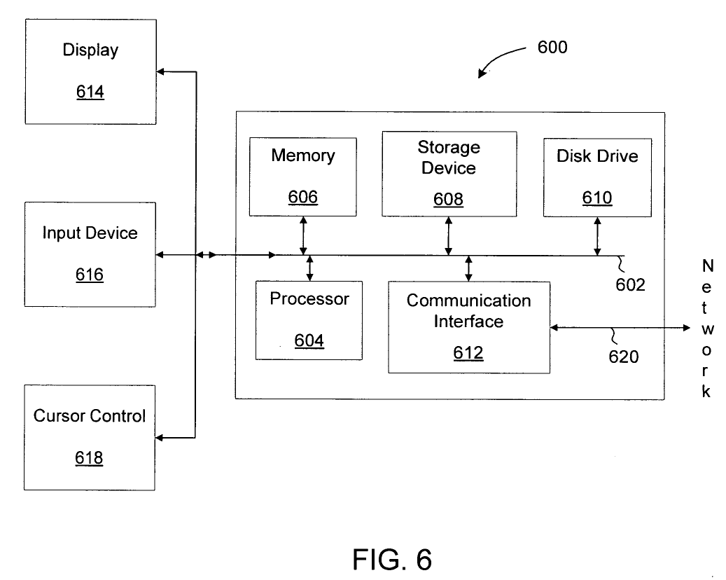

FIG. 6 illustrates an exemplary computer system suitable for distributed media player branding. In some examples, computer system 600 may be used to implement computer programs, applications, methods, processes, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some examples, computer system 600 performs specific operations by processor 604 executing one or more sequences of one or more instructions stored in system memory 606. Such instructions may be read into system memory 606 from another computer readable medium, such as static storage device 608 or disk drive 610. In some examples, hard-wired circuitry may be used in place of or in combination with software instructions for implementation.

The term “computer readable medium” refers to any medium that participates in providing instructions to processor 604 for execution. Such a medium may take many forms, including but not limited to, non-volatile media, volatile media, and others. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602 for transmitting a computer data signal.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In some examples, execution of the sequences of instructions may be performed by a single computer system 600. According to some examples, two or more computer systems 600 coupled by communication link 620 (e.g., LAN, PSTN, or wireless network) may perform the sequence of instructions in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

1. (canceled)

2. (canceled)

3. The method of claim 15, wherein the visual element comprises an avatar.

4. The method of claim 15, wherein the visual element comprises a skin associated with the other media player.

5. The method of claim 14, wherein the other brand is received as part of other data, further comprising determining a format of the other data.

6. The method of claim 5, wherein the format comprises a video associated with the second media player.

7. The method of claim 5, wherein the format comprises a web page associated with the second media player.

8. The method of claim 14, wherein the voice communication and the data are provided over the data communication link.

9. (canceled)

10. (canceled)

11. The method of claim 14, wherein the other brand is received as part of other data, wherein the first media player has access to a location, wherein the first media player is configured to store and access the other data from the location.

12. The method of claim 11, wherein the location is associated with a website.

13. (canceled)

14. A method, comprising:
a first media player requesting to initiate communication with a second media player and sending data that includes a brand associated with the first media player to the second media player, wherein the brand is presentable on the second media player to modify one or more elements of the second media player;
once the brand is presented on the second media player, beginning communication between the first and second media players; and
receiving another brand associated with the second media player by the first media player when the first media player and the second media player are in voice communication, wherein the another brand is presentable on the first media player to modify one or more elements of the first media player.

15. The method of claim 14, wherein the one or more elements comprises a visual element.

16. The method of claim 14, wherein the one or more elements comprises an audio element.

17. The method of claim 14, wherein the one or more elements comprises an animation.

18. (canceled)

19. A system, comprising:
a memory configured to store program instructions; and
a processor configured to execute the program instructions to implement:
a first media player requesting to initiate voice communication with a second media player and sending data that includes a brand associated with the first media player to the second media player, wherein the brand is presentable on the second media player to modify one or more elements of the second media player;
once the brand is presented on the second media player, beginning communication between the first and second media players; and
receiving another brand associated with the second media player by the first media player when the first media player and the second media player are in voice communication, wherein the another brand is presentable on the first media player to modify one or more elements of the first media player.

20. (canceled)

21. The system of claim 19, wherein the brand is configured to identify the first media player.

22. (canceled)

23. A computer program product embodied in a non-transitory computer readable medium and comprising computer instructions for:
a first media player requesting to initiate communication with a second media player and sending data that includes a brand associated with the first media player to the second media player, wherein the brand is presentable on the second media player to modify one or more elements of the second media player;
once the brand is presented on the second media player, beginning communication between the first and second media players; and
receiving another brand associated with the second media player by the first media player when the first media player and the second media player are in communication, wherein the another brand presentable on the first media player to modify one or more elements of the first media player.

24. The method of claim 14, wherein the one or more elements of the second media player includes a button.

25. A method, comprising:
receiving, by a media player, a request to initiate communication with another media player;
receiving a brand associated with the other media player, wherein the brand is configured to modify one or more elements associated with the media player;
presenting the brand on a display used by the media player, wherein said presenting includes modifying a visual appearance of the display of the media player; and
once the brand is presented on the media player, beginning communication between the media player and other media player.

26. The method of claim 25, wherein modifying the visual appearance of the display includes presenting a graphical representation of the brand on the media player.

27. The method of claim 25, wherein the data communication and the brand are provided over a same data link.

28. A computer program product embodied in a non-transitory computer readable medium and comprising computer instructions for:
receiving, by a media player, a request to initiate communication with another media player;
receiving a brand associated with the other media player, wherein the brand is configured to modify one or more elements associated with the media player;
presenting the brand on a display used by the media player, wherein said presenting includes modifying a visual appearance of the display of the media player; and
once the brand is presented on the media player, beginning communication between the media player and other media player.
